(19) United States
(12) Patent Application Publication
(10) Pub. No.: US 2010/0020021 A1
(43) Pub. Date: Jan. 28, 2010

(54) TOUCH SCREEN CONTROL SYSTEM AND METHOD

(75) Inventors: JULIE ANNE MILLS, MADISON, WI (US); ROBERT THAM, MIDDLETON, WI (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, SCHENECTADY, NY (US)

(21) Appl. No.: 12/177,219

(22) Filed: Jul. 22, 2008

(51) Int. Cl. G06F 3/041

(52) U.S. Cl. 345/173

(57) ABSTRACT

A control system is disclosed herein. The control system includes a touch screen, and a computer operatively connected to the touch screen. The computer is configured to identify a first position at which the touch screen is contacted. The computer can identify the first position at any portion of the touch screen such that a user can blindly establish the first position. The computer is also configured to identify a second position at which the touch screen is contacted; estimate the magnitude and direction of the difference between the first position and the second position; and regulate a control parameter based on the magnitude and direction of the difference between the first position and the second position.

### BACKGROUND OF THE INVENTION

The subject matter disclosed herein relates to a touch screen control system and method.

Conventional touch screen devices comprise a display that can detect the location of points of contact within the display area. Touch screen devices are commonly menu driven such that a user establishes contact with specific regions of the display area in order to select a menu item. In this manner, the display can function as a device adapted to visually convey data as well as an input device.

One problem with conventional touch screen devices is that a user must visually engage the touch screen in order to identify the display area regions with which contact is to be made. This can be problematic in that the process of visually engaging a touch screen may divert the users attention away from a potentially more important activity thereby creating a distraction.

### BRIEF DESCRIPTION OF THE INVENTION

The above-mentioned shortcomings, disadvantages and problems are addressed herein which will be understood by reading and understanding the following specification.

In an embodiment, a method includes identifying a first position at which a touch screen is contacted. The first position is identifiable at any portion of the touch screen such that a user can blindly establish the first position. The method also includes identifying a second position at which the touch screen is contacted, and estimating the magnitude and direction of the difference between the first position and the second position. The method also includes regulating a control parameter based on the magnitude and direction of the difference between the first position and the second position.

In another embodiment, a control system includes a touch screen, and a computer operatively connected to the touch screen. The computer is configured to identify a first position at which the touch screen is contacted. The computer can identify the first position at any portion of the touch screen such that a user can blindly establish the first position. The computer is also configured identify a second position at which the touch screen is contacted; estimate the magnitude and direction of the difference between the first position and the second position; and regulate a control parameter based on the magnitude and direction of the difference between the first position and the second position.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram illustrating a control system in accordance with an embodiment;

FIG. 2 is a schematic diagram illustrating an anesthesia system in accordance with an embodiment; and

FIG. 3 is a flow chart illustrating an algorithm in accordance with an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

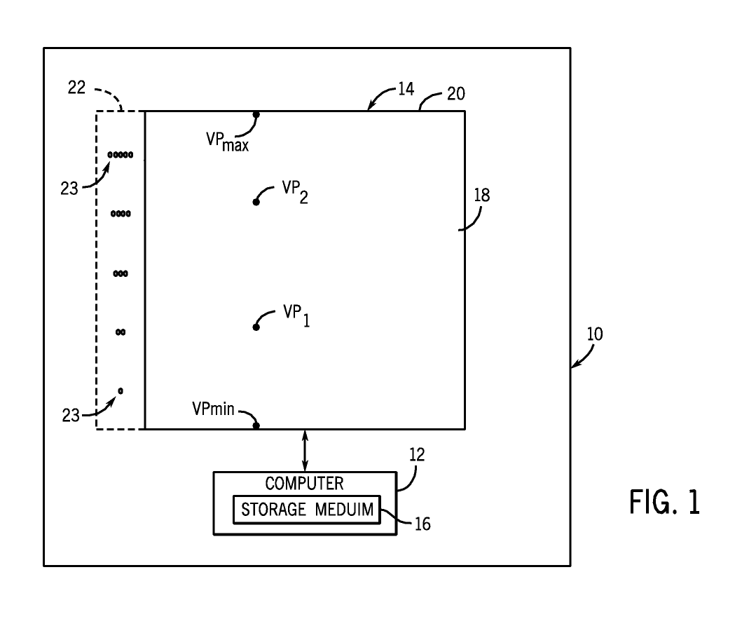

Referring to FIG. 1, a control system 10 is shown in accordance with an embodiment. The control system 10 includes a computer 12 operatively connected to a display 14. The computer 12 includes a computer-readable storage medium 16 such as a hard drive, RAM, CD, DVD, etc. The display 14 includes a touch screen 18 defining peripheral edges 20.

The display 14 may optionally include a tactile guide 22 adapted to enable a user to tactilely identify the relative position of a point of contact. According to one embodiment, the tactile guide 22 may comprise raised features such as the dots 23 disposed so that the quantity and/or density increase in an upward direction. In this manner, a user can touch the tactile guide 22 without directly looking at the display 14 in order to tactilely identify the dots 23 and thereby estimate a vertical position of a point of contact. In other words, if a user establishes contact with a portion of the tactile guide 22 and tactilely identifies a sequence of five dots 23, they can assume they are near the top of the touch screen 18. It should be appreciated that the tactile guide 22 represents an exemplary embodiment, and that alternate tactile guide configurations, orientations and/or features can be envisioned.

According to another embodiment, the tactile guide 22 can be disposed directly over the touch screen 18, and can be positioned relative to the touch screen 18 in a manner adapted to identify a specific control parameter. Therefore, a user can implement the tactile guide 22 in order to select one of several control parameters to be regulated.

The control system 10 will hereinafter be described in accordance with an embodiment wherein it is implemented as part of an anesthesia system 30; however it should be appreciated that the control system 10 may alternatively be implemented in a variety of other devices.

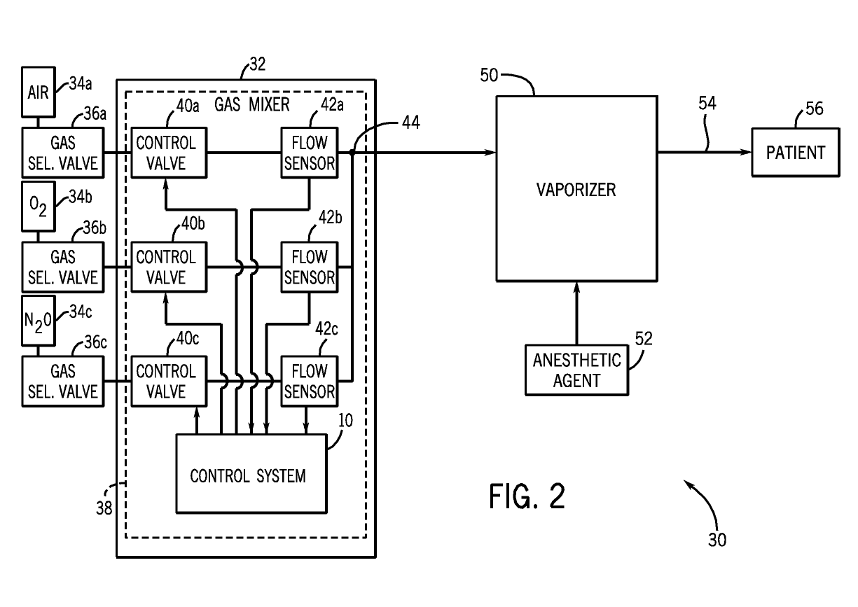

Referring to FIG. 2, the anesthesia system 30 is schematically depicted in accordance with one embodiment. The anesthesia system 30 includes an anesthesia machine 32, a plurality of gas storage devices 34a, 34b and 34c, and a vaporizer 50. In a typical hospital environment, the gas storage devices 34a, 34b and 34c each comprise a centrally located storage tank configured to supply medical gas to multiple hospital rooms via a wall outlet. The storage tanks are generally pressurized to facilitate the transfer of the medical gas to the anesthesia machine 32.

The gas storage devices 34a, 34b and 34c will hereinafter be described for illustrative purposes as comprising an air tank 34a, an oxygen (O2) tank 34b, and a nitrous oxide (N2O) tank 34c. The gas storage tanks 34a, 34b and 34c are each connected to one of the gas selector valves 36a, 36b, and 36c. The gas selector valves 36a, 36b, and 36c may be implemented to shut off the flow of medical gas from the storage tanks 34a, 34b and 34c when the anesthesia machine 32 is not operational. When one of the gas selector valves 36a, 36b, and 36c is opened, gas from a respective storage tank 34a, 34b and 34c is transferred under pressure to the anesthesia machine 32.

The anesthesia machine 32 includes a gas mixer 38 adapted to receive medical gas from the storage tanks 34a, 34b and 34c. The gas mixer 38 includes a plurality of control valves 40a, 40b and 40c that are respectively connected to one of the gas selector valves 36a, 36b, and 36c. The gas mixer 38 also includes a plurality of flow sensors 42a, 42b and 42c that are each disposed downstream from a respective control valve 40a, 40b, and 40c. After passing through one of the control valves 40a, 40b, and 40c, and passing by one of the flow sensors 42a, 42b and 42c, the air, O2 and N2O are combined to form a mixed gas at the mixed gas outlet 44.

The control valves 40a, 40b and 40c and the flow sensors 42a, 42b and 42c are each connected to the control system 10. The control system 10 is configured to operate the control valves 40a, 40b and 40c in response to user input and/or gas flow rate feedback from the sensors 42a, 42b and 42c. According to one embodiment, a user can specify air, O2 and N2O concentrations via the touch screen 18 (shown in FIG. 1) of the control system 10, and thereafter the computer 12 (shown in FIG. 1) regulates the control valves 40a, 40b and 40c in a manner adapted to produce the user specified concentrations of air, O2 and N2O at the mixed gas outlet 44. The computer 12 may additionally be configured to adjust the control valves 40a, 40b and 40c in response to feedback from the sensors 42a, 42b and 42c if, for example, the measured concentrations of the air, O2 and N2O are inconsistent with the user specified concentrations.

The mixed gas from the mixed gas outlet 44 is transferred to the vaporizer 50. The vaporizer 50 is configured to vaporize an anesthetic agent 52, and to combine the vaporized anesthetic agent with the mixed gas from the mixed gas outlet 44. The vaporized anesthetic agent and mixed gas combination passes through a breathing tube 54 and is delivered to the patient 56.

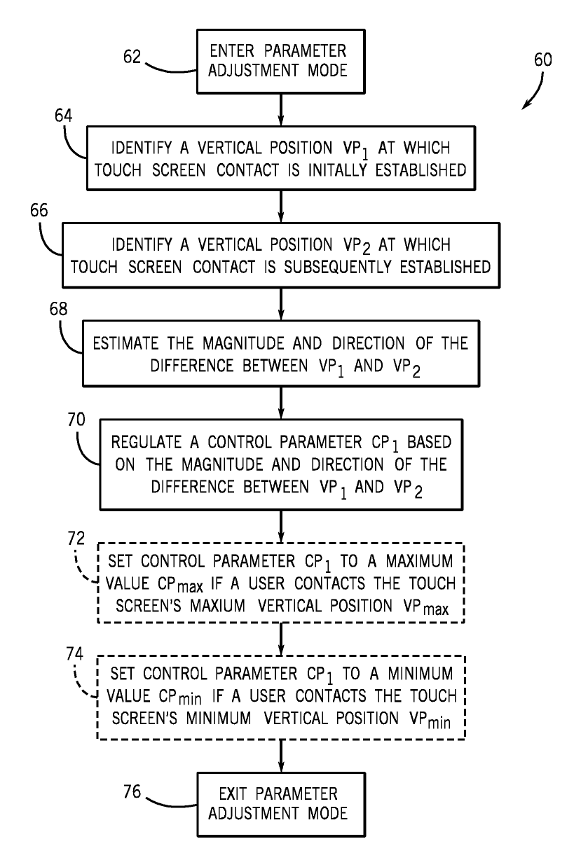

Referring to FIG. 3, a flow chart illustrating an algorithm 60 is shown in accordance with an embodiment. The technical effect of the algorithm 60 is to enable a user to operate the control system 10 with out directly looking at the touch screen 18 such that the operator can, for example, remain focused on the patient 56 (shown in FIG. 2). The ability to remain focused on the patient is particularly advantageous in the context of an anesthesia system wherein valuable information such as patient skin color and chest movement could otherwise be lost. According to one embodiment, the algorithm 60 comprises a computer program stored on the computer-readable storage medium 16 (shown in FIG. 1). The individual blocks 62-76 represent steps that can be performed by the computer 12 (shown in FIG. 1).

The algorithm 60 will hereinafter be described in accordance with an embodiment wherein touch screen contact is evaluated in a vertical direction for purposes of regulating anesthesia machine operation. It should, however, be appreciated that alternate embodiments may implement similar concepts based on the evaluation of touch screen contact in other directions (e.g., a horizontal direction).

Referring to FIGS. 1 and 3, at step 62 the algorithm 60 is configured to enter a virtual touch screen parameter adjustment mode. The virtual touch screen parameter adjustment mode is a mode adapted to facilitate the regulation of a specific control parameter. At this step, the control parameter to be regulated can also be selected.

At step 64 the algorithm 60 is configured to identify a vertical position VP1 at which touch screen contact is initially established. Step 64 may implement any of a variety of different known touch screen technologies in order to identify vertical position VP1. Initial touch screen contact can occur anywhere on the surface of the touch screen 18 such that a user can initiate control system 10 operation by randomly engaging any portion of the touch screen 18 and without directly observing the display 14. Accordingly, the initial touch screen contact can be blindly established by a user that is visually focused on the patient 56. For purposes of this disclosure, the term blindly established touch screen contact refers to the process of engaging or contacting the touch screen in a manner that does not require visual observation of the touch screen.

At step 66, the algorithm 60 is configured to identify a vertical position VP2 at which touch screen contact is subsequently established. In other words, after a user establishes initial touch screen contact at vertical position VP1, any subsequent touch screen contact at a vertical position other than VP1 can be defined as VP2. According to one embodiment, if touch screen contact is continuously maintained between two or more positions, the algorithm 60 defines VP2 as the last point of contact prior to disengagement. This embodiment would allow a user to define positions VP1 and VP2 by blindly establishing initial contact with a random portion of the touch screen surface (i.e., VP1), dragging their finger across the touch screen's surface to a user selectable terminal position (i.e., VP2), and then disengaging the touch screen 18.

At step 68, the algorithm 60 is configured to estimate the magnitude and direction of the difference between VP1 and VP2. According to the illustrative embodiment depicted in FIG. 3 the algorithm 60 identifies whether VP2 is vertically above or below VP1, and estimates the vertical distance between VP1 and VP2.

At step 70, the algorithm 60 is configured to regulate a control parameter CP1 based on the magnitude and direction of the difference between VP1 and VP2. For illustrative purposes, the control parameter CP1 will hereinafter be described as comprising O2 concentration. The following will provide several non-limiting embodiments illustrating the operation of step 70.

According to one embodiment, at step 70 the algorithm 60 is configured to increase control parameter CP1 in proportion to the degree by which VP2 exceeds VP1 as measured in a vertical direction. As an example, if a user blindly touches the touch screen 18 at vertical position VP1 and slides their finger in an upward direction to a vertical position that is only slightly above VP1, the computer 12 will open the control valve 40b by an amount sufficient to slightly increase O2 concentration. If a user blindly touches the touch screen 18 at vertical position VP1 and slides their finger in an upward direction to a vertical position that exceeds VP1 by a greater amount, the computer 12 will open the control valve 40b by an amount sufficient to more dramatically increase O2 concentration.

According to another embodiment, at step 70 the algorithm 60 is configured to decrease the control parameter CP1 in proportion to the degree by which VP2 falls below VP1 as measured in a vertical direction. As an example, if a user blindly touches the touch screen 18 at vertical position VP1 and slides their finger in a downward direction to a vertical position that is only slightly below VP1, the computer 12 will close the control valve 40b by an amount sufficient to slightly decrease O2 concentration. If a user blindly touches the touch screen 18 at vertical position VP1 and slides their finger in a downward direction to a vertical position that is farther below VP1, the computer 12 will close the control valve 40b by an amount sufficient to more dramatically decrease O2 concentration.

According to yet another embodiment, at step 70 the algorithm 60 may be configured to scale or otherwise modify the amount of change to be made to the control parameter CP1 based on the duration between VP1 and VP2.

Step 72 is an optional step wherein the algorithm 60 sets the control parameter CP1 to a maximum value if a user contacts the touch screen's maximum vertical position VPmax. Accordingly, a user can blindly touch the touch screen 18 at an arbitrary vertical position and slide their finger in an upward direction until they reach the upper peripheral edge 20 in order to quickly maximize the control parameter CP1.

Step 74 is an optional step wherein the algorithm 60 sets the control parameter CP1 to a minimum value if a user contacts the touch screen's minimum vertical position VPmin. Accordingly, a user can blindly touch the touch screen 18 at an arbitrary vertical position and slide their finger in a downward direction until they reach the lower peripheral edge 20 in order to quickly minimize the control parameter CP1.

At step 76 the algorithm 60 is configured to exit the virtual touch screen parameter adjustment mode. After exiting the virtual touch screen parameter adjustment mode, the touch screen 18 can resume normal operation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A method comprising:
identifying a first position at which a touch screen is contacted, said first position being identifiable at any portion of the touch screen such that a user can blindly establish the first position;
identifying a second position at which the touch screen is contacted;
estimating the magnitude and direction of the difference between the first position and the second position; and
regulating a control parameter based on the magnitude and direction of the difference between the first position and the second position.

2. The method of claim 1, wherein said regulating a control parameter comprises increasing a control parameter in proportion to the degree by which the second position exceeds the first position.

3. The method of claim 1, wherein said regulating a control parameter comprises decreasing a control parameter in proportion to the degree by which the first position exceeds the second position.

4. The method of claim 1, wherein said regulating a control parameter comprises regulating a control parameter of an anesthesia machine.

5. The method of claim 1, wherein said regulating a control parameter comprises regulating one of an air concentration, an oxygen concentration, a nitrous oxide concentration, and an anesthetic agent concentration.

6. The method of claim 1, further comprising setting the control parameter to a maximum value if the touch screen is contacted at a maximum vertical position.

7. The method of claim 1, further comprising setting the control parameter to a minimum value if the touch screen is contacted at a minimum vertical position.

8. A control system comprising:
a touch screen; and
a computer operatively connected to the touch screen, said computer configured to:
identify a first position at which the touch screen is contacted, said computer being configured to identify the first position at any portion of the touch screen such that a user can blindly establish the first position;
identify a second position at which the touch screen is contacted;
estimate the magnitude and direction of the difference between the first position and the second position; and
regulate a control parameter based on the magnitude and direction of the difference between the first position and the second position.

9. The control system of claim 8, wherein the computer is configured to increase the control parameter in proportion to the degree by which the second position exceeds the first position.

10. The control system of claim 8, wherein the computer is configured to decrease the control parameter in proportion to the degree by which the first position exceeds the second position.

11. The control system of claim 8, wherein the control parameter comprises a control parameter of an anesthesia machine.

12. The control system of claim 8, wherein the control parameter comprises one of an air concentration, an oxygen concentration, a nitrous oxide concentration, and an anesthetic agent concentration

13. The control system of claim 8, wherein the computer is configured to maximize the control parameter if the touch screen is contacted at a maximum vertical position.

14. The control system of claim 8, wherein the computer is configured to minimize the control parameter if the touch screen is contacted at a minimum vertical position.

15. The control system of claim 8, further comprising a tactile guide.
